(19) United States
(12) Patent Application Publication
(10) Pub. No.: US 2012/0002223 A1
(43) Pub. Date: Jan. 5, 2012

(54) IMAGE FORMING APPARATUS AND A PAPER SHEET SUPPLY METHOD

(75) Inventor: Norio Tanaka, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 13/171,404

(22) Filed: Jun. 28, 2011

Related U.S. Application Data
(60) Provisional application No. 61/360,458, filed on Jun. 30, 2010.

(30) Foreign Application Priority Data
Dec. 24, 2010 (JP) P2010-286836

(51) Int. Cl. G06K 15/02

(52) U.S. Cl. 358/1.9

(57) ABSTRACT

An image forming apparatus, comprising: an input unit which designates the type of a sheet to be used in image formation; a sheet cassette which accommodates the sheets and in which the type of the accommodated sheets is set; a storage unit which stores the sheet type set in the sheet cassette if the sheet type set in the sheet cassette and the sheet type accommodated in the sheet cassette coincide with each other; and a control unit which, when the sheet type set in the sheet cassette is stored in the storage unit upon receiving a request of image formation, judges whether the sheet type designated by the input unit and the sheet type stored in the storage unit coincide with each other, if the sheet type designated by the input unit and the sheet type stored in the storage unit coincide with each other, said control unit instructs image formation, if the sheet type designated by the input unit and the sheet type stored in the storage unit do not coincide, said control unit notifies the judgment result to a user without instructing the image formation, and when the sheet type is not stored in the storage unit upon receiving the request of the image formation, said control unit instructs the image formation.

### CROSS-REFERENCE TO RELATED APPLICATION

The application is based upon and claims the benefit of priority from U.S. Provisional Application No. 61/360,458, filed Jun. 30, 2010; further this application is based upon and claims the benefit of priority from Japanese Patent Application No. P2010-286836, filed on Dec. 24, 2010; the entire contents of which are incorporated herein by references.

### FIELD

Embodiments described herein relate generally to an image forming apparatus and a paper sheet supply method of the image forming apparatus.

### BACKGROUND

In general, in an image forming apparatus a plurality of types of a paper size is prepared for a paper which is supplied into the image forming apparatus. And they are accommodated in separated paper cassettes and used. Although the paper size accommodated in each paper cassette is set up, the paper size which is set up is different from the paper size actually accommodated in the paper cassette. For example, because it is possible for a user to change the set up paper size in the paper cassette freely, there is a case that the paper having different size from the set up size is accommodated in the sheet cassette without noticing the change.

A print operation can be started at the time when there was a request of printing, even if the paper size set in the paper cassette is different from the actual paper size. When the paper size set in the paper cassette is different from the actual paper size, there is a possibility that an error such as a paper jam etc., which is caused by a mistake of the paper size in the middle of the printing operation, is occurred. That is, since a suitable paper set in the paper cassette is not accommodated in the paper cassette, the error is occurred.

### BRIEF DESCRIPTION OF THE DRAWINGS

FIG. 1 is a schematic configuration diagram of an image forming apparatus.

FIG. 2 is a block diagram showing a process unit of the image forming apparatus in a first embodiment.

FIG. 3 is a flowchart of a method for selecting a paper cassette which supplies a paper in the first embodiment.

FIG. 4 is an example diagram showing a warning display

FIG. 5 is a block diagram showing a process unit of the image forming apparatus in a second embodiment.

FIG. 6 is a flowchart of a method for selecting a paper cassette which supplies a paper in the second embodiment.

FIG. 7 is a schematic diagram showing a paper carrier path in a third embodiment.

FIG. 8 is a flowchart of a method for selecting a paper cassette which supplies a paper in the third embodiment.

### DETAILED DESCRIPTION

It is an object of embodiments which the invention applies to that an image forming apparatus which can prevent an error due to inconsistency between the paper type set up in a paper cassette and the paper type actually accommodated in the paper cassette is provided.

It is provided that an image forming apparatus comprising: an input unit which designates the type of a sheet to be used in image formation; a sheet cassette which accommodates the sheets and in which the type of the accommodated sheets is set; a storage unit which stores the sheet type set in the sheet cassette when the sheet type set in the sheet cassette and the sheet type accommodated in the sheet cassette coincide with each other; and a control unit which, when the sheet type set in the sheet cassette is stored in the storage unit upon receiving a request of image formation, judges whether the sheet type designated by the input unit and the sheet type stored in the storage unit coincide with each other, if the sheet type designated by the input unit and the sheet type stored in the storage unit coincide with each other, said control unit instructs image formation, if the sheet type designated by the input unit and the sheet type stored in the storage unit do not coincide, said control unit notifies the judgment result to a user without instructing the image formation, and when the sheet type is not stored in the storage unit upon receiving the request of the image formation, said control unit instructs the image formation.

Hereafter, the embodiment in the present invention is described with reference to drawings.

### A First Embodiment

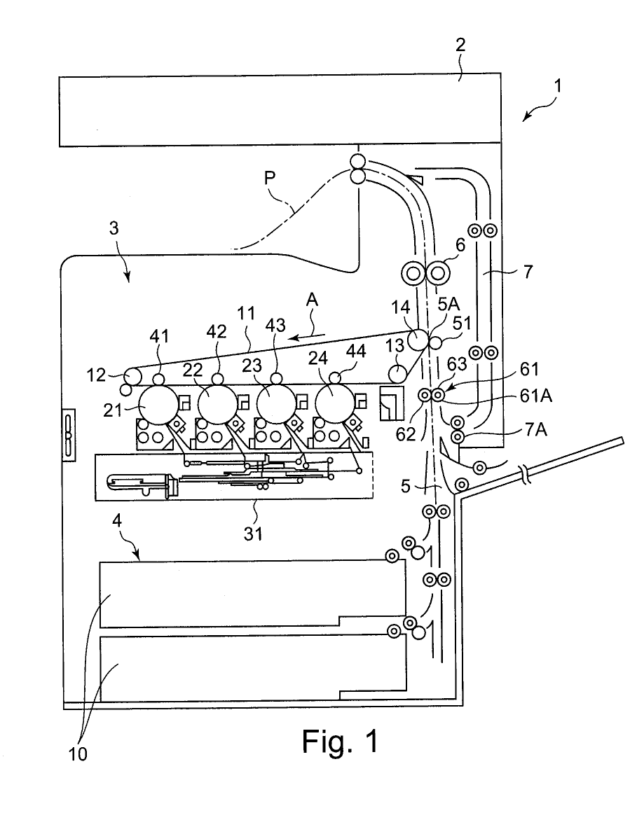

A first embodiment will be described by using FIGS. 1 to 4.

FIG. 1 is a schematic cross-sectional view of an image forming apparatus to which an embodiment of the present invention is applied.

An image forming apparatus 1 shown in FIG. 1 includes a scanner unit 2 which generates an image signal by capturing image information of a document as light contrast and an image forming unit 3 which transfers an output image visualized by developer, that is, toner to a transfer medium, that is, a paper sheet P based on the image signal, and then fixes the transferred image to output the image.

The image forming apparatus 1 further has a sheet holder 4 comprising a plurality of sheet cassettes 10 each of which holds an arbitrary number of paper sheets P of different type and can supply the paper sheet P one by one below the image forming unit 3. In the present embodiment, it is assumed that the size of the sheet is the type of the sheet.

The size of the sheets contained in each of the sheet cassettes 10 is previously set. As described later, setting of the size of the sheets contained in each of the sheet cassettes 10 can be changed by a user. The sheet cassette 10 comprises an open/close detection sensor (not shown) thereby to detect whether the sheet cassette 10 is opened or closed by the user.

The paper sheet P contained in the sheet holder 4 is supplied according to the timing of forming the output image in the image forming unit 3.

A conveying path 5 serving as a sheet conveying part which guides the paper sheet P from the sheet holder 4 to the image forming unit 3 is provided between the sheet holder 4 and the image forming unit 3. The conveying path 5 guides the paper sheet P to a fixing unit 6, which fixes a toner image transferred to the sheet P onto the sheet P through a transfer position 5A at which the toner image formed in the image forming unit 3 is transferred to the sheet P.

The image forming unit 3 has an intermediate transfer belt 11 made of a belt shaped insulating film of a predetermined thickness, for example. The intermediate transfer belt 11 may be a thin metal sheet whose surface is protected by resin or the like.

The intermediate transfer belt 11 is subjected to a predetermined tension by a driving roller 12, a first tension roller 13, and a second tension roller 14, and the driving roller 12 is rotated to move an arbitrary position of the intermediate transfer belt 11 parallel to the axis line of the driving roller 12 in the direction of arrow A. In other words, the belt surface of the intermediate transfer belt 11 is circulated in one direction at a speed of the movement of the outer peripheral surface of the driving roller 12.

In a section where the belt surface of the intermediate transfer belt 11 is moved in a substantially planar state as the predetermined tension is applied thereto by the rollers 12, 13, and 14, first to fourth image forming units 21, 22, 23, and 24 are arranged at a predetermined interval. In the example shown in FIG. 1, in the section where the intermediate transfer belt 11 is moved in a substantially planar state between the driving roller 12 and the first tension roller 13, the first image forming unit 21 is disposed at the driving roller 12 side, and the fourth image forming unit 24 is disposed at the first tension roller 13 side.

The first to fourth image forming units 21 to 24 respectively include at least developing devices storing toners of colors C (cyan), M (magenta), Y (yellow) and BK (black) and photoreceptors, for example, photoreceptor drums holding electrostatic images to be developed by the respective developing devices. On the photoreceptors of the respective image forming units, electrostatic images of the colors to be developed by the developing devices in the image forming units are formed by image light from an exposure device 31, and then toner is supplied by the corresponding developing devices, whereby the electrostatic images are developed.

Transfer rollers 41 to 44 are provided on the back surface side of the intermediate transfer belt 11 corresponding to the first to fourth image forming units 21 to 24 in a state that the intermediate transfer belt 11 is interposed between the first to fourth image forming units 21 to 24 and the transfer rollers 41 to 44. The transfer rollers 41 to 44 are used for transferring the toner images as developer images onto the intermediate transfer belt 11, the toner images as developer images being formed by the developing devices developing the electrostatic images on the photoreceptors of the respective image forming units. In the respective image forming units 21 to 24, the electrostatic images are sequentially formed on the respective photoreceptors at a predetermined timing so that the toner images transferred sequentially are mutually superimposed on the intermediate transfer belt 11, and the electrostatic images are developed by the developing devices.

The toner images superimposed on the intermediate transfer belt 11 is transferred onto the paper sheet P, which is conveyed to the transfer position 5A, by a transfer roller 51 brought into contact with the intermediate transfer belt 11 with a predetermined pressure at the transfer position 5A on the conveying path 5. When a toner image is not required to be transferred onto the paper sheet P, a roller release mechanism (not shown) moves the transfer roller 51 to a retracting position where the transfer roller 51 is not contacted with the intermediate transfer belt 11.

The toner image transferred onto the paper sheet P is fixed by the fixing unit 6 and then discharged to a discharge part.

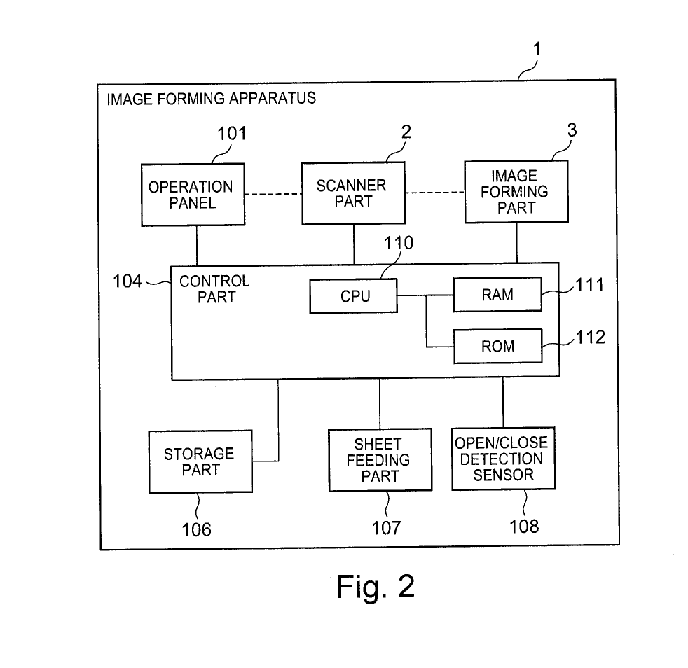

Next, a processing part which performs various processes in the image forming apparatus 1 according to the present embodiment will be described. FIG. 2 shows a block diagram of the processing part of the image forming apparatus 1 according to the present embodiment.

The image forming apparatus 1 includes an operation panel 101, the scanner unit 2, the image forming unit 3, a control unit 104, a storage unit 106, a sheet feeding part 107, and an open/close detection sensor 108 of the sheet cassette 10.

The operation panel 101 is a user interface serving as an input unit for receiving an operation instruction from a user. The operation panel 101 includes a hard key such as a numeric keypad and a display device with a built-in touch panel, for example a touch key of a display part such as an LCD (Liquid Crystal Display). A user inputs the operation instruction through the operation panel 101.

As described above, the scanner unit 2 converts an image of a document into image data, and the image forming unit 3 forms an image on a recording medium.

The control unit 104 is provided with a CPU (Central Processing Unit) 110, a RAM (Random Access Memory) 111, and a ROM (Read Only Memory) 112. The CPU 110 is a processor which takes charge of the entire control of the control unit 104. The RAM 111 is a memory which temporarily stores working data and stores reference data. The ROM 112 is a non-volatile memory and stores a control program and control data for controlling the image forming apparatus 1. The CPU 110 realizes various processes and various functions by operating based on the control program stored in the ROM 112. The sheet cassette from which the paper sheets are fed to the image forming unit 103 is selected by the control unit 104. Although the CPU 110 is used as a processor, the kind of processors is not limited thereto.

The storage unit 106 is a rewritable memory and can store the sizes of the sheets contained in the sheet cassettes 10 arranged in the sheet holder 4 of the image forming apparatus 1. The sheet feeding part 107 picks up the sheet contained in the sheet cassette 10 and conveys the sheet to the transfer position 5A.

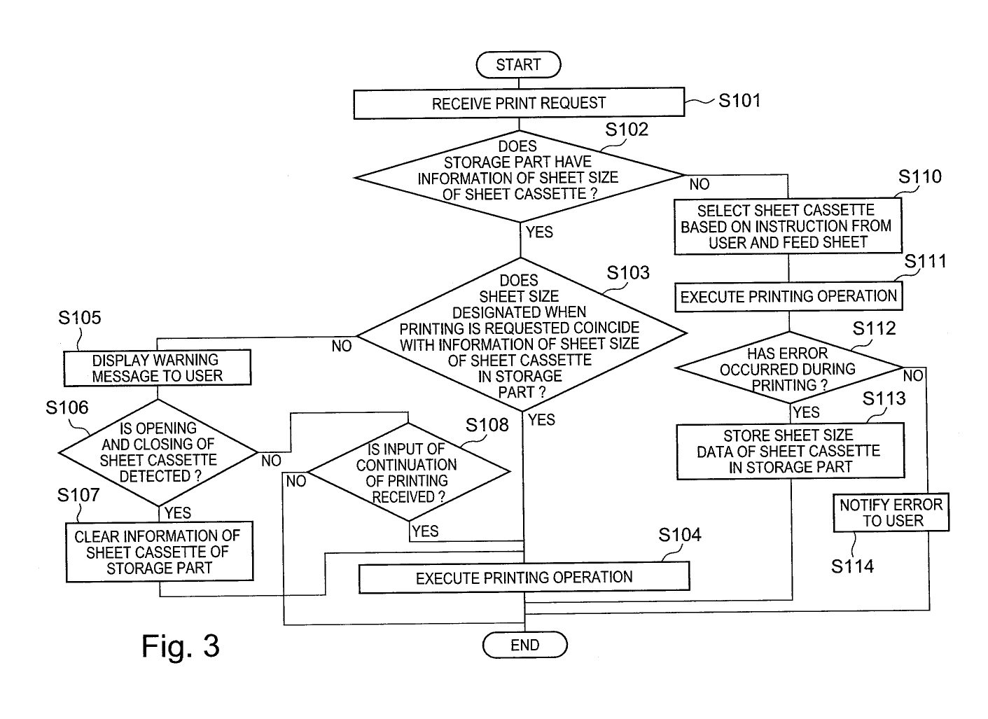

Next, a method of selecting the sheet cassette from which the paper sheets are fed according to the present embodiment will be described. FIG. 3 is a flow chart showing the method of selecting the sheet cassette from which the paper sheets are fed.

When the CPU 110 receives a print request including print setting information from a user through the operation panel 101, for example (S101), the CPU 110 judges whether the storage unit 106 has information of a sheet size of the sheet cassette 10 (S102).

When the CPU 110 judges that the storage unit 106 has the information of the sheet size of the sheet cassette 10 (YES in S102), the CPU 110 judges whether the sheet size that is one of the print setting information designated by the user in the print request coincides with the sheet size of the sheet cassette 10 stored in the storage unit 106 (S103).

When the CPU 110 judges that the sheet size designated by the user coincides with the sheet size of the sheet cassette 10 stored in the storage unit 106 (YES in S103), the sheet feeding part 107 feeds the paper sheet from the sheet cassette 10 and executes printing operation (S104).

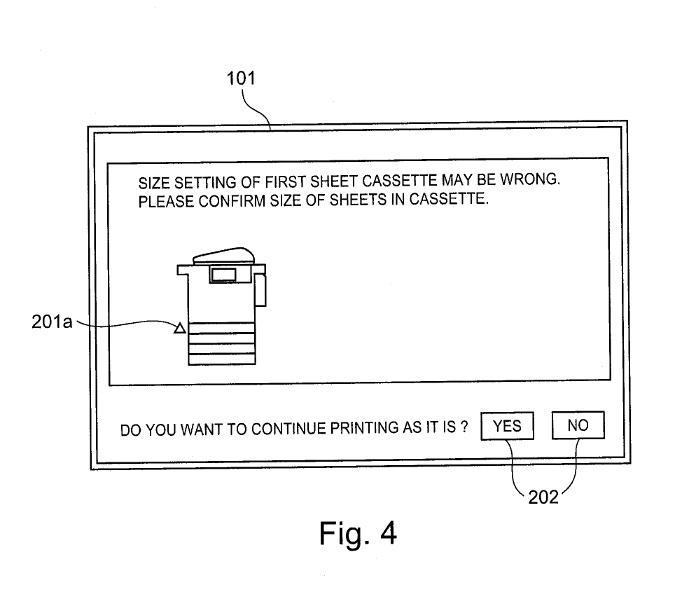

When the CPU 110 judges that the sheet size designated by the user does not coincide with the sheet size of the sheet cassette 10 stored in the storage unit 106 (NO in S103), the printing operation is not performed, and a warning is given to the user (S105). For example, a warning screen shown in FIG. 4 is displayed on the operation panel 101 of the image forming apparatus 1. At that time, the sheet cassette 10 with the sheet size that does not coincide with the sheet size designated by the user is shown by an illustration or a photograph as represented by a remarkable point 201a of FIG. 4, whereby the user easily recognizes the sheet cassette 10 to be confirmed so that convenience is enhanced.

When the user opens or closes the sheet cassette 10 after the warning is given to the user, the opening or closing of the sheet cassette 10 is detected by the open/close detection sensor 108 (YES in S106), and the CPU 110 clears the information of the sheet size of the sheet cassette 10 in the storage unit 106 (S107). Thereafter, printing is executed (S104).

When the opening and closing of the sheet cassette 10 is not detected by the open/close detection sensor 108 (NO in S106), the CPU 110 judges whether the user wants to continue printing without modification (S108). Whether the user wants to continue printing without modification is input by the user touching a touch key 202 of the operation panel 101 of FIG. 4, for example.

When the CPU 110 recognizes the input of the continuation of printing from the user (YES in S108), the printing operation is executed (S104). When the CPU 110 does not recognize that the user inputs the continuation of printing, that is, when the CPU 110 recognizes the touching on “NO” of the touch key 202 of FIG. 4 (NO in S108), processing is terminated without executing the printing operation.

In S102, when the CPU 110 judges that the storage unit 106 does not have the information of the sheet size of the sheet cassette 10 (NO in S102), the paper sheet is fed from the sheet cassette 10 in which the sheet size designated by the user is previously set (S110), and the printing operation is executed (S111). After the execution of the printing operation, the CPU 110 judges whether an error is detected during printing (S112). When no error is detected and printing is performed normally (YES in S112), data of the sheet size set in the sheet cassette 10 is stored in the storage unit 106 (S113). In this case, the sheet size set in the sheet cassette 10 is judged to be the same as the size of the sheets actually contained in the sheet cassette 10.

If an error such as jamming occurs during printing (NO in S112), appropriate paper sheets may not be contained in the sheet cassette 10, and therefore, the data of the sheet size of the sheet cassette 10 is not stored in the storage unit 106. The error is notified to a user (S114), and the processing is terminated. In this case, the size of the sheets actually contained in the sheet cassette 10 is judged to be different from the sheet size set in the sheet cassette 10.

Next, a case where the data of the sheet size of the sheet cassette 10 is deleted from the storage unit 106 will be described. The data of the sheet size of the sheet cassette 10 is deleted from the storage unit 106 when the open/close detection sensor 108 of the sheet cassette 10 detects the opening of the sheet cassette 10 and when the open/close detection sensor 108 is shifted from an unavailable state to an available state. The opening and closing of the sheet cassette 10 is detected by the open/close detection sensor 108 not only when printing is requested as shown in the flow chart of FIG. 3, but the detection is performed as long as when the open/close detection sensor 108 is working.

The case where the open/close detection sensor 108 is shifted from the unavailable state to the available state namely means a case where the open/close detection sensor 108 is shifted from a non power supplied state to a power supplied state.

When the power is not supplied to the open/close detection sensor 108 and the open/close detection sensor 108 is in the unavailable state, even if the sheet cassette 10 is opened, the sensor cannot detect that. When the open/close detection sensor 108 is in the unavailable state, the sheets in the sheet cassette 10 may be exchanged with another sheets. The open/close detection sensor 108 may be unavailable when a power supply of the image forming apparatus 1 itself is turned off, or when the image forming apparatus 1 is in a power saving mode so that the power is not supplied to the open/close detection sensor 108. Accordingly, when the open/close detection sensor 108 is shifted from the unavailable state to the available state, in consideration of the above possibility, the data of the sheet size stored in the storage unit 106 is deleted.

According to the above embodiment, when the size of the sheets actually contained in the sheet cassette 10 is different from the sheet size set in the sheet cassette 10, the printing operation is not started so that an error due to a mistake of the sheet size can be prevented. Further, a waste of the sheet due to an unintended output result can be prevented.

In the above embodiment, although the size of the sheet is exemplified as the type of the sheet, the type of the sheet is not limited thereto. For example, when a paper sheet having a thickness different from that of plain paper such as thick paper is used, the thickness of paper may be judged as the type of the paper sheet. When a sheet of a material different from that of plain paper such as glossy paper is used, the material of the sheet may be judged as the type of the sheet.

Further, in the present embodiment, since whether the size of the paper sheets contained in the sheet cassette 10 coincides with the sheet size set in the sheet cassette 10 is judged based on whether the printing is performed normally, a measurement device such as a sensor measuring the sheet size is not required to be provided. Thus, the device configuration is simplified.

### Second Embodiment

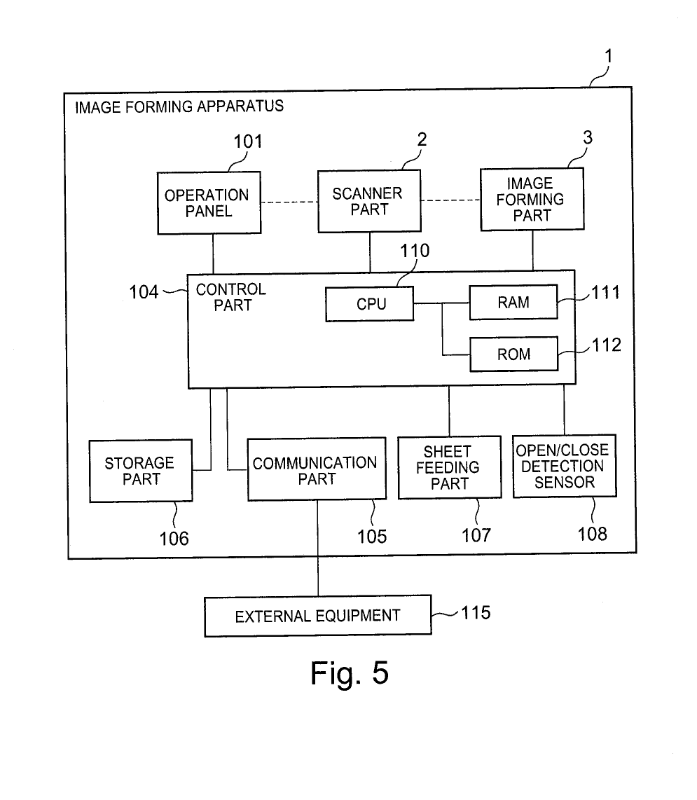

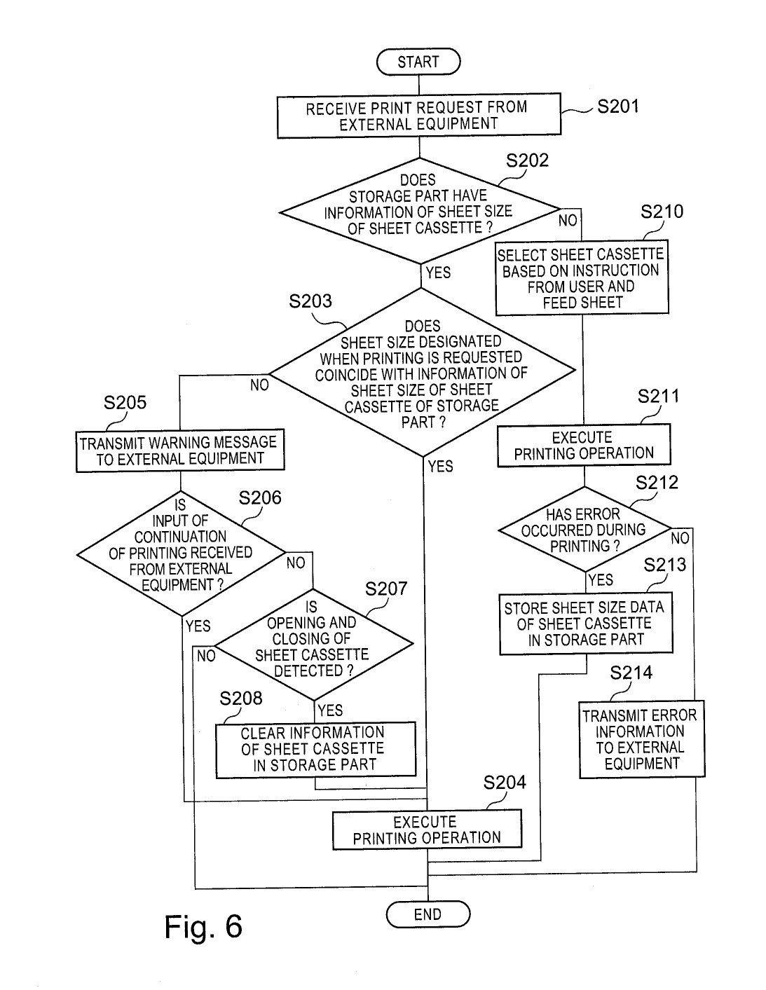

A second embodiment will be described using FIGS. 5 and 6.

Hereinafter, the same components as those of the above embodiment are denoted by the same reference numerals, and only the features of the present embodiment will be described. In the present embodiment, even when the user requests printing from a printer driver of an external apparatus connected to an image forming apparatus 1, similar effects to the first embodiment can be obtained.

FIG. 5 is a block diagram of a processing part of the image forming apparatus 1 according to the present embodiment. In the present embodiment, a communication part 105 which communicates with external equipment 115 is provided in addition to the configuration of the first embodiment. Examples of the external equipment 115 include a PC (Personal Computer) having a printer driver of the image forming apparatus 1. As such, in the present embodiment, a print instruction can be sent to the image forming apparatus 1 through the printer driver of the external equipment 115.

FIG. 6 is a flow chart showing a method of selecting a sheet cassette from which the paper sheets are fed according to the present embodiment.

When the CPU 110 of the image forming apparatus 1 receives a print request including print setting information from the user through the printer driver of the external equipment 115 (S201), the CPU 110 judges whether the storage unit 106 has information of the sheet size of the sheet cassette 10 (S202).

When the CPU 110 judges that the storage unit 106 has the information of the sheet size of the sheet cassette 10 (YES in S202), the CPU 110 judges whether the sheet size designated by the user in the print request coincides with the sheet size of the sheet cassette 10 stored in the storage unit 106 (S203).

When the CPU 110 judges that the sheet size designated by the user coincides with the sheet size of the sheet cassette 10 stored in the storage unit 106 (YES in S203), the paper sheet is fed from the sheet cassette 10, and the printing operation is executed (S204).

When the CPU 110 judges that the sheet size designated by the user does not coincide with the sheet size of the sheet cassette 10 stored in the storage unit 106 (NO in S203), the printing operation is not performed, and a warning message is transmitted to the external equipment 115 for the purpose of informing the user (S205). The user can receive the warning message through the external equipment 115. At that time, simultaneously therewith, the warning message may be displayed on an operation panel 210 of the image forming apparatus 1 as in the first embodiment.

When the user wants to continue printing regardless of the displayed warning message, the user can send an instruction of continuation of printing to the image forming apparatus 1 through the printer driver of the external equipment 115. In the image forming apparatus 1, when the CPU 110 recognizes the reception of the printing continuation instruction from the external equipment 115 (YES in S206), the printing operation is continued (S204).

When the CPU 110 does not recognize the reception of the printing continuation instruction from the user (NO in S206), whether the opening and closing of the sheet cassette 10 is detected by an open/close detection sensor 108 is judged (S207). When the sheet cassette 10 is opened or closed by the user, the opening and closing of the sheet cassette 10 is detected by the open/close detection sensor 108 (YES in S207), and the CPU 110 clears the information of the sheet size of the sheet cassette 10 of the storage unit 106 (S208). Thereafter, printing is executed (S204). When the opening and closing of the sheet cassette 10 is not detected by the open/close detection sensor 108 (NO in S207), the processing is terminated.

In step S202, when the CPU 110 judges that the storage unit 106 does not have the information of the sheet size of the sheet cassette 10 (NO in S202), the paper sheet is fed from the sheet cassette 10 in which the sheet size designated by the user is set (S210), and the printing operation is executed (S211). After the execution of the printing operation, the CPU 110 judges whether an error is detected during the printing (S212). When no error is detected and printing is performed normally (YES in S212), data of the sheet size of the sheet cassette 10 is stored in the storage unit 106 (S213).

If an error such as jamming occurs during the printing (NO in S212), appropriate paper sheets may not be contained in the sheet cassette 10, and therefore, the data of the sheet size of the sheet cassette 10 is not stored in the storage unit 106. Then, error information is transmitted to the external equipment 115 (S214). The error is notified to a user, and thereafter the processing is terminated.

According to the above embodiment, since the user can recognize whether appropriate paper sheets are contained in the sheet cassette 10 when the user requests printing from the printer driver, the convenience for users is improved.

### Third Embodiment

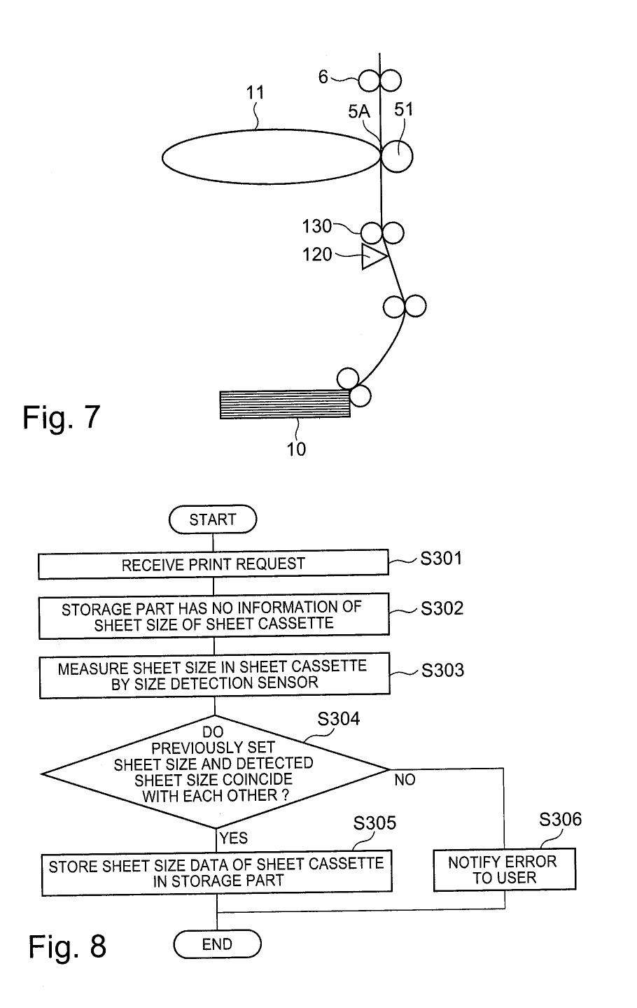

A third embodiment will be described using FIGS. 7 and 8.

Hereinafter, the same components as those of the above embodiment are denoted by the same reference numerals, and only the features of the present embodiment will be described.

FIG. 7 is a simplified schematic diagram of a sheet conveying part of the present embodiment.

In the present embodiment, the image forming apparatus 1 has a size detection sensor 120 as a measurement part which measures the sheet size and is provided at a portion of a resist roller pair 130, which temporarily stops a sheet before a transfer position. If printing is executed when a storage unit 106 does not have information of the sheet size of the sheet cassette 10, the sheet size of the paper sheets contained in the sheet cassette 10 is measured by the size detection sensor 120. Then, whether the size of the paper sheets P contained in the sheet cassette 10 coincides with the sheet size set in the sheet cassette 10 is judged by the CPU 110, whereby whether the paper sheets of the correct sheet size are contained in the sheet cassette 10 is judged.

In the present embodiment, when the storage unit 106 has the information of the sheet size of the sheet cassette 10, the processing similar to that in the first embodiment is performed. As the feature of the present embodiment, when the storage unit 106 does not have the information of the sheet size of the sheet cassette 10, the size of the paper sheets actually contained in the sheet cassette 10 is measured.

FIG. 8 is a flow chart showing a method of selecting the sheet cassette from which the paper sheets are fed when the storage unit 106 does not have the information of the sheet size of the sheet cassette 10 according to the present embodiment.

First, the CPU 110 receives a print request from the user (S301). When the CPU 110 judges that the storage unit 106 does not have the information of the sheet size of the sheet cassette 10 after the reception of the print request (S302), the paper sheet is picked up from the sheet cassette 10, and the sheet size of the paper sheets contained in the sheet cassette 10 is detected by the size detection sensor 120 (S303).

After the detection of the sheet size in S303, the CPU 110 judges whether the previously set sheet size of the sheet cassette 10 coincides with the sheet size detected in S303 (S304).

When the CPU 110 judges that the previously set sheet size of the sheet cassette 10 coincides with the sheet size detected in S303 (YES in S304), data of the sheet size of the sheet cassette 10 is stored in the storage unit 106 (S305).

When the CPU 110 judges that the previously set sheet size of the sheet cassette 10 does not coincide with the sheet size detected in S303 (NO in S304), an error is notified to the user (S306), and the processing is terminated.

According to the above embodiment, even in the first printing in which the sheet size of the sheet cassette 10 is not stored in the storage unit 106, when the size of the paper sheets actually contained in the sheet cassette 10 does not coincide with the sheet size set in the sheet cassette 10, the printing operation can be discontinued.

In the above embodiment, although the size detection sensor 120 which detects the sheet size is provided at the portion of the resist roller pair 130, the size detection sensor 120 may be provided at another position.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus, comprising:
an input unit which designates the type of a sheet to be used in image formation;
a sheet cassette which accommodates the sheets and in which the type of the accommodated sheets is set;
a storage unit which stores the sheet type set in the sheet cassette when the sheet type set in the sheet cassette and the sheet type accommodated in the sheet cassette coincide with each other; and
a control unit which, when the sheet type set in the sheet cassette is stored in the storage unit upon receiving a request of image formation, judges whether the sheet type designated by the input unit and the sheet type stored in the storage unit coincide with each other,
if the sheet type designated by the input unit and the sheet type stored in the storage unit coincide with each other, said control unit instructs image formation,
if the sheet type designated by the input unit and the sheet type stored in the storage unit do not coincide, said control unit notifies the judgment result to a user without instructing the image formation,
and when the sheet type is not stored in the storage unit upon receiving the request of the image formation, said control unit instructs the image formation.

2. The image forming apparatus according to claim 1, wherein when the image formation is performed normally in the case where the sheet type is not stored in the storage unit, the sheet type set in the sheet cassette is stored in the storage unit.

3. The image forming apparatus according to claim 1 further comprising,
a communication unit which communicates with external equipment,
wherein designation of the sheet type to be used in the image formation is received from the external equipment through the communication unit and
if the sheet type designated by the external equipment and the sheet type stored in the storage unit do not coincide, a notification to the user is sent to the external equipment through the communication unit.

4. The image forming apparatus according to claim 1 further comprising, an open/close detection sensor which detects the opening and closing of the sheet cassette,
wherein after the open/close detection sensor detects the opening of the sheet cassette or after the open/close detection sensor is shifted from an unavailable state to an available state, the control unit deletes the sheet type of the sheet cassette stored in the storage unit.

5. The image forming apparatus according to claim 1,
wherein the sheet type is the size of the sheet.

6. The image forming apparatus according to claim 5 further comprising,
a measurement unit which measures the size of the paper sheet fed from the sheet cassette,
wherein when the sheet size is not stored in the storage unit, the control unit measures the size of the paper sheet supplied from the sheet cassette by the measurement unit to perform the image formation,
and if the measured sheet size coincides with the sheet size set in the sheet cassette, the control unit stores, in the storage unit, the coincided sheet size as the sheet size set in the sheet cassette.

7. The image forming apparatus according to claim 6,
wherein if the measured sheet size does not coincide with the sheet size set in the sheet cassette, the control unit notifies the measurement result to the user.

8. A method of supplying a sheet, comprising:
setting a sheet type in a sheet cassette;
receiving a designation of the type of a sheet to be used in image formation;
storing the sheet type set in the sheet cassette;
when the sheet type is stored in the memory upon the reception of a request of the image formation, judging whether the designated sheet type and the stored sheet type coincide with each other, if the designated sheet type and the stored sheet type coincide with each other, instructing the image formation,
and if the designated sheet type and the stored sheet type do not coincide, notifying the judgment result to the user without instructing the image formation; and
when the sheet type is not stored in the memory upon the reception of a request of the image formation, instructing the image formation.

9. The method of supplying a paper sheet according to claim 8, wherein when the image formation is performed normally in the case where the sheet type is not stored in the memory, storing the sheet type set in the sheet cassette in the memory.

10. The method of supplying a paper sheet according to claim 8, further comprising:
communicating with an external equipment;
receiving the designation of the type of the sheet to be used in the image formation from the external apparatus through a communication unit; and
if the sheet type designated by the external equipment and the sheet type stored in the memory do not coincide, sending a notification addressing to the user to the external equipment.

11. The method of supplying a paper sheet according to claim 8, further comprising:
detecting opening and closing of the sheet cassette by an open/close detection sensor;
deleting the sheet type stored in the memory after the detection of the opening of the sheet cassette or after the open/close detection sensor is shifted from an unavailable state to an available state.

12. The method of supplying a paper sheet according to claim 8,
wherein the sheet type is the size of the sheet.

13. The method of supplying a paper sheet according to claim 12, further comprising:
when the sheet size is not stored in the memory, measuring the size of the sheet supplied from the sheet cassette in the image formation; and
if the measured sheet size coincides with the sheet size set in the sheet cassette, storing the coincided sheet size in the memory as the sheet size set in the sheet cassette.

14. The method of supplying a paper sheet according to claim 13 further comprising,
if the measured sheet size does not coincide with the sheet size set in the sheet cassette, notifying the measurement result to the user.

15. An image forming apparatus comprising,
an image forming unit which forms an image on a sheet;
a sheet accommodated unit which accommodates the sheet to form the image by said image forming unit, wherein a sheet type information of the sheet accommodated in said sheet accommodated unit is set in said sheet accommodated unit;
a storage unit which stores the sheet type information set in said sheet accommodated unit,
wherein when the image formation is normally executed by said image forming unit in the case where the sheet type information is not stored in said storage unit, the sheet type information set in said sheet accommodated unit is stored in the storage unit.

16. The image forming apparatus according to claim 15 further comprising,
an input unit which inputs the sheet type information of the sheet to be formed by said image forming unit;
wherein said image forming unit forms the image on the sheet based on the sheet type information input by said input unit, when said storage unit does not store the sheet type information.

17. The image forming apparatus according to claim 15 further comprising,
an input unit which inputs the sheet type information of the sheet to form the image by said image forming unit;
wherein, if the sheet type information input by said input unit corresponds to the sheet type information stored in the storage unit, said image forming unit forms the image on the sheet.

18. The image forming apparatus according to claim 17,
wherein, if the sheet type information input by said input unit does not correspond to the sheet type information stored in the storage unit, a notification to a user is executed without an image formation.

19. The image forming apparatus according to claim 18,
wherein when the sheet type information set in said sheet accommodated unit is stored in said storage unit upon receiving a request of an image formation by said image forming unit, the image forming apparatus judges whether the sheet type information input by said input unit corresponds to the sheet type information stored in the storage unit

20. The image forming apparatus according to claim 19,
wherein said storage unit stores the sheet type information set in said sheet accommodated unit if the sheet type information set in said accommodated unit corresponds to a sheet type accommodated in said sheet accommodated unit.
